(19) United States
(12) Patent Application Publication
(10) Pub. No.: US 2002/0049773 A1
(43) Pub. Date: Apr. 25, 2002

(54) Method of providing a reference standard within a web site on an internet

(76) Inventor: Kristin Madonna Jaramillo, Union Lake, MI (US)

Correspondence Address: Avery N. Goldstein, Gifford, Krass, Groh, Sprinkle,, Anderson & Citkowski, P.C., 280 N. Old Woodward Avenue, Suite 400, Birmingham, MI, 48009-5394, US

(21) Appl. No.: 09/862,096

(22) Filed: May 21, 2001

Related U.S. Application Data
(60) Provisional application No. 60/205,745, filed on May 19, 2000.

(51) Int. Cl. G06F 7/00

(52) U.S. Cl. 707/104.1

(57) ABSTRACT

A method of providing a reference standard on a web site on an Internet includes the steps of providing a web site having a reference standard database on a computer network. The method also includes the steps of identifying if a user has permission to access the reference standard database on the web site and selecting a search criteria for a reference standard by the user, if the user has permission to access the reference standard database. The method further includes the steps of searching the reference standard database for the reference standard using the search criteria and providing the user with the reference standard identified by the search of the reference standard database.

### RELATED APPLICATIONS

This application claims priority of U.S. Provisional Application Serial No. 60/205,745 filed May 19, 2000, entitled “Web-Based Industry Standards Reference” and is incorporated herein by reference.

### BACKGROUND OF THE INVENTION

1. Field of the Invention

The present invention relates generally to an internet and, more specifically, to a method of providing a reference standard within a web site on an internet.

2. Description of the Related Art

An internet, and in particular the Internet, is a globally recognized system of interconnected networks that utilize a standardized Internet Protocol (IP) as the network layer protocol. The Internet, also referred to as the World Wide Web, or the Web, is an accepted gateway providing a user with interactive access to information, goods or services, through the use of hypermedia. A user can access a particular location of the Web, referred to as a web site, using an address written in a commonly accepted language, such as HyperText Transfer Protocol (HTTP). The content and format of a web site on the Web is written in another commonly accepted language, such as HyperText Markup Language (HTML), which is a computer language used to specify the content and format of a hypermedia document.

The Internet provides a user with access to a vast amount of information located in computer databases in communication with the Internet. Various finding aids are known in the art for locating information. One example of a finding aid is a class of software tools referred to as search engines. The search engine utilizes automated software programs referred to as robots or spiders, that transverse the Internet cataloging documents and storing the information in a computer database, where it is filtered, categorized and stored. It should be appreciated that web pages can also be part of the searchable database.

Another example of a finding aid is an information alert service, also referred to as an e-mail alert service. The e-mail alert service is typically associated with a web site, and the host e-mails information to the user based on the user's interests.

One effect of the recent growth and widespread use of the Web is the development of E-commerce, which is the transaction of business through the use of the Internet. In particular, the business hosts a web site to offer a service or product to a user accessing the web site. E-commerce facilitates interaction between the business and a user, regardless of their respective physical locations.

Technically related industries and governments worldwide rely on reference standards to ensure that materials, products, processes and services are fit for their intended purpose. The reference standard typically includes technical specifications, or other such precise criteria, to be used as rules, guidelines or definitions for the particular material, product, process or service. Examples of types of reference standards include quality standards, safety standards and process standards. It should be appreciated that within a particular industry, such as construction, a country may set its own unique standard.

Reference standards are typically stored in a database or library, which may be computer based. A disadvantage of these databases is that each is maintained by a particular company, industry or government. Another disadvantage is that these databases do not utilize a common document control system for maintaining the standards located therein. Features of a document control system include the ability to identify the standards maintained therein using a master list, tracking of the revision status of each standard, making the document available once located, removal of the out of date standards from the database and assurance that the standard is current and accurate.

Since reference standards are maintained in a number of different databases and in a number of different formats, searching for and procurement of a standard is difficult. Thus, there is need in the art for a method of searching for and making available a reference standard using the Internet in a timely manner.

### SUMMARY OF THE INVENTION

Accordingly, the present invention is a method of providing a reference standard within a web site on the Internet. The method includes the steps of providing a web site having a reference standard database on a computer network. The method also includes the steps of identifying if a user has permission to access the reference standard database on the web site and selecting a search criteria for a reference standard by the user, if the user has permission to access the reference standard database. The method further includes the steps of searching the reference standard database for the reference standard using the search criteria and providing the user with the reference standard identified by the search of the reference standard database.

One advantage of the present invention is that a method of providing a reference standard within a web site on the Internet is provided that offers a user intermediate access to a reference standard database containing reference standards from various sources, including companies, industries and governments. Another advantage of the present invention is that an interactive search process is used to locate standards within the reference standard database using different search criteria, including name of company, product, service, keyword or language. Still another advantage of the present invention is that current reference standards are maintained in a common database.

Other features and advantages of the present invention will be readily appreciated, as the same become better understood after reading the subsequent description taken in conjunction with the accompanying drawings.

### BRIEF DESCRIPTION OF THE DRAWINGS

FIG. 1 is a block diagram of a system for use with a method of providing a reference standard within a web site on an internet, according to the present invention;

FIG. 2 is a block diagram of a web site for providing a reference standard for use with the system of FIG. 1, according to the present invention; and

FIG. 3 is a flowchart of a method of providing a reference standard within a web site on an internet, according to the present invention.

### DESCRIPTION OF THE PREFERRED EMBODIMENT(S)

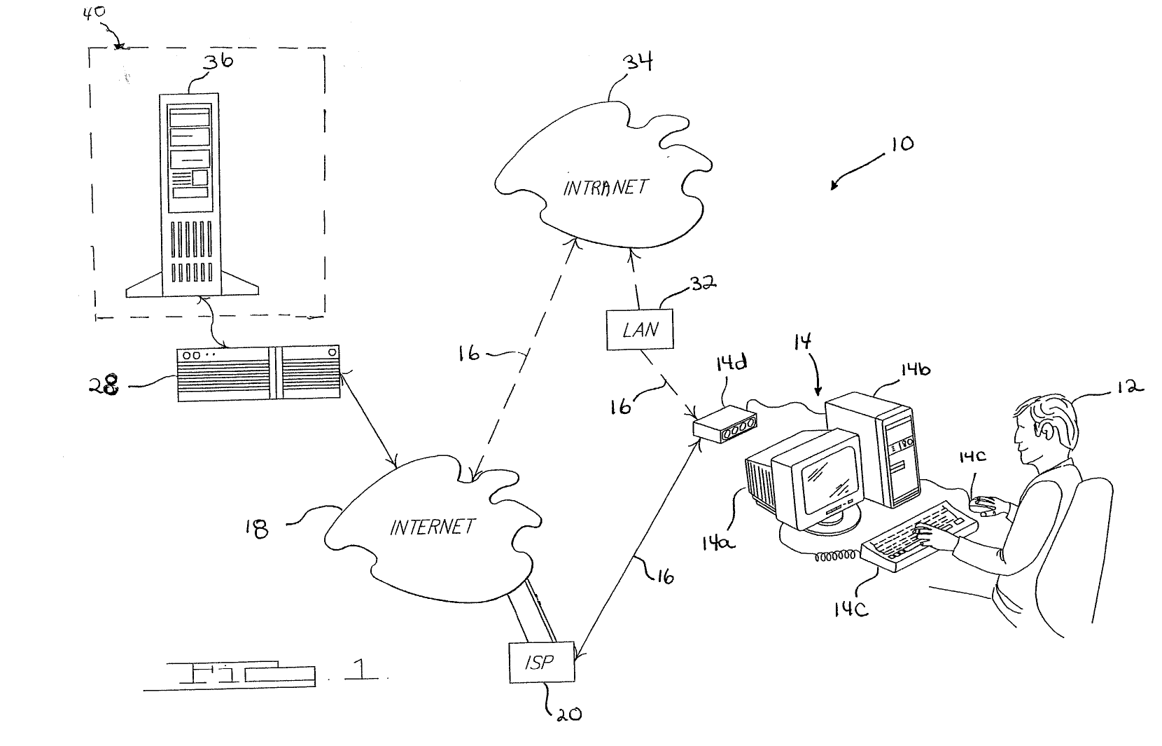

Referring to FIG. 1, an embodiment of a system for use with a method of providing a reference standard within a web site on an internet, and in particular the Internet 18, is illustrated. The system includes a user 12 having a computer 14. It should be appreciated that the user 12 can be an individual, corporation, or the like. The user's computer 14 includes a video monitor 14a, a processor 14b, an input device 14c such as a keyboard or a mouse, and a modem 14d, as is known in the art.

The user's computer 14 is connected to the infrastructure of the Internet 18 via a telecommunication link 16, such as a telephone line or a cable line or a wireless connection. As is known in the art, the Internet 18 includes providers, such as Internet Access Providers (IAPs) (not shown), Internet Service Providers (ISPs) 20 and Network Service Providers (NSPs) (not shown) and routers 28 that provide wired and wireless digital telecommunications throughout the world using a TCP/IP networking protocol. It should be appreciated that the computer 14 may access the Internet 18 directly, or may be operatively connected to a Local Area Network (LAN) 32 over which information is transmitted to other computers on the same LAN 32 or to computers on other LANS 32 through a localized Intranet 34. The information can be transmitted between the user 14 and the Internet 18 via the Intranet 34.

The system includes an E-commerce web site 40 having a server 36 that interactively communicates with the user 12 through the user's computer 14 via the Internet 18. The web site server 36 is a computer system operatively connected to a provider 20 in a conventional manner. The web site 40 provides for interactive communication between the host of the web site 40 and a visitor to the web site 40. The communication is facilitated by a series of screens, referred to as pages, displayed on the display screen, with the first page referred to as a home page. When the user 12 visits a particular web site 40, the user 12 is served a page displayed on the video monitor 14a referred to as a home page. The user 12 may interact with the page via the input device 14c, such as by making a selection or a request.

The system 10 also includes a user identification system, whereby a computer 14 accessing the Internet 18 is assigned a unique user ID and IP (Internet Protocol) address. Preferably, the IP address is a specific sequence of numbers assigned to the user 12 for a specific provider 20. The IP address is temporarily assigned to the user 12 for the length of time the computer 14 is connected to the provider 20. Thus, transmission of data from the web site 40 through the provider 20 to the user's computer 14 in response to a request by the user 12, is addressed to the unique IP address associated with the provider 20 for the current connection to the Internet 18. It should be appreciated that this system 10 is conventional and known in the art.

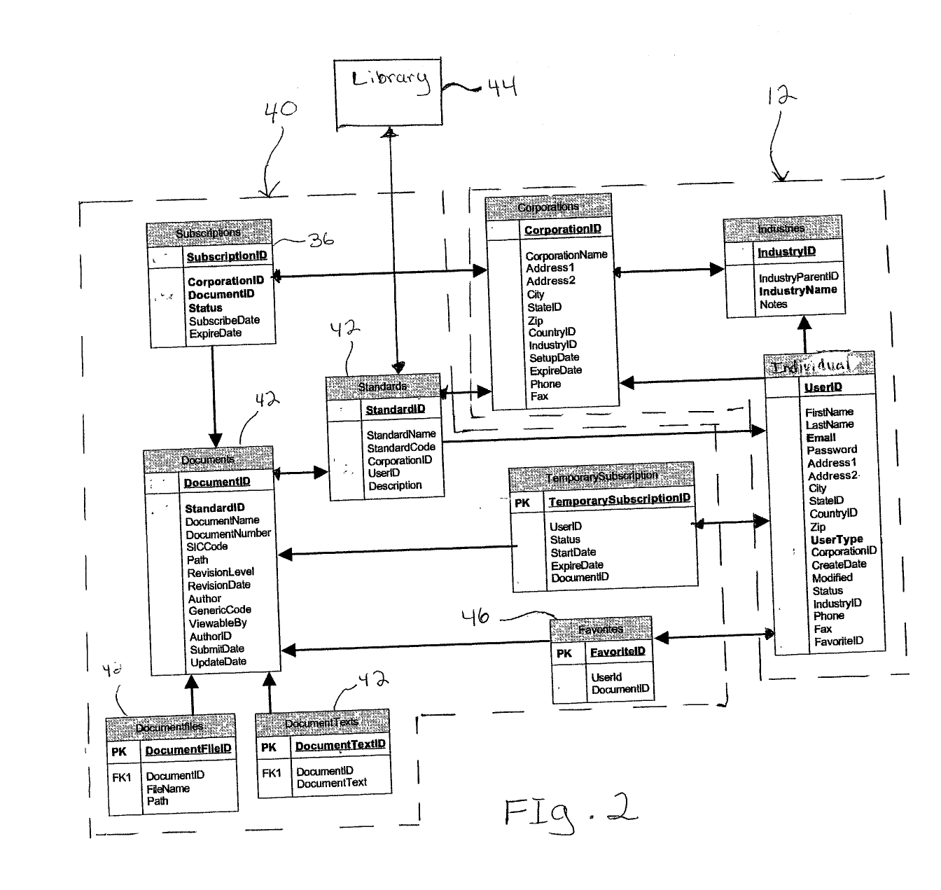

Referring to FIG. 2, the web site 40 for providing a reference standard to a user 12 via an E-commerce web site is illustrated. The web site 40 includes a document storage database as shown at 42 for storing documents, and in particular reference standards. Preferably, document storage database 42 is a server, or a cluster of servers acting as one. The reference standards are provided to the document storage database 42 from a variety of sources, shown at 44, including government libraries and industry libraries. Preferably, the document storage database includes a plurality of databases organized in a predetermined manner for reference standards. For example, the databases may be organized by country or subject matter. It should be appreciated that the reference standards may be received by the document storage database 42 in a variety of different formats, and may be reformatted or otherwise identified, to facilitate searching of these reference standards. Examples of identification tags include standard number, author, subject code, submission date, update date, revision level, or industry code.

Advantageously, reference standards for a company can be maintained in a customized company library, as shown at 46. Further, the web site 40 can maintain an e-mail alert service to notify a user 12 that a standard they have designated has been revised. In addition, the web site 40 can be used as an organization's library, providing publication of and access to their reference standards.

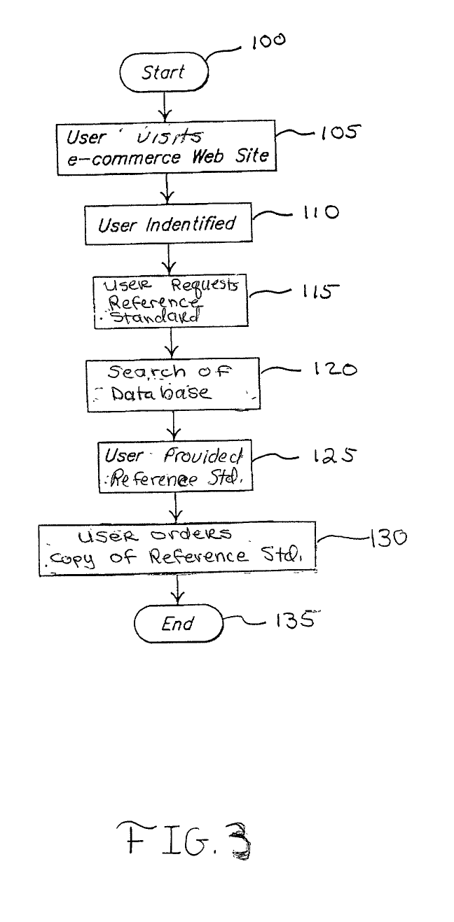

Referring to FIG. 3, a method of providing a reference standard within a web site on an internet is illustrated for a user within the system of FIG. 1. The method begins in block 100 and continues to block 105 with a user 12 visiting an E-commerce web site 40. Preferably, the web site is an E-commerce web site for storage and retrieval of reference standards, as previously described.

The method advances to block 110 and the user 12 is identified by the web site 40, such as by logging on. The user 12 may be prompted to provide an identification code and a password, as is known in the art. If the user 12 is new to the web site 40, the web site obtains information regarding the user 14. If the user 12 is not new to the web site 40, the web site retrieves data regarding the user 12.

It is anticipated that various types of users 12 will access the web site. One example of a user 12 is an individual who accesses the web site 40 and pays a fee for the service provided by the web site 40 on a per-use basis. Another example is for a user 12 that subscribes to the web site 40 for predetermined access to the reference standard services by paying a predetermined subscription fee. As a reference standard subscription service, the user 14 agrees to pay a predetermined fee for a predetermined period of time for the service, and the reference standard subscription service agrees to provide the user with the reference standards. It is contemplated that an individual or organization such as a company or government entity may subscribe to the service provided by the web site, and be assigned an identifying code.

The web server 40 identifies the user 12, such as from a database of subscribers or from a previous visit to the web site. As is known in the art, when a user 12 visits a web site, a code identifying the user 12 is embedded in a cookie stored on the user's computer 14. Alternatively, the user 12 may be identified using an on-line guest book for the web site 40, and the user 12 signs in when visiting the web site 40. Preferably, the user 12 has provided the guest book with information about the user 12, such as name, mailing address, e-mail address, phone numbers or subscription identification. The methodology advances to block 115.

In block 115, the user 12 requests a reference standard using a predetermined search format. For example, the user 12 is served a web page with various search options available for selection. Typically, the first page is referred to as a home page. The user 12 utilizes the user interactive device 14c to provide their input.

The methodology advances to block 120 and the web site server 40 searches its database. For example, the web site server 40 includes a search engine that queries the database, finds a set of answers, and displays the answers on the user's display terminal 14a. The user 14 can modify the search for the reference standard based upon the displayed results. One example of a search engine technique is asynchronous query execution, wherein the server directly executes the request with the database. It should be appreciated that the web site server may be organized as a multi-tiered network architecture, to optimize the search request and response.

One example of a search format option is to select a particular standard from a master list of reference standards. In another example, the user 12 provides a keyword relevant to the desired reference standard. Preferably, the keyword relates to the reference standard, such as subject matter, author, date, country, company or industry. The web site 40 utilizes its search engine, as previously described, to locate the desired reference standard within its database 42. It should be appreciated that this step may require several iterations, especially if the user 14 is conducting a generalized search for reference standards. The methodology advances to block 125.

In block 125 the reference standard is made available to the user 14. Advantageously, the user may select how the results of the search for the reference standard are displayed on the display terminal 14a. For example, the results may be organized by company, date relevance or author. The user 14 can select to view more information about a particular reference standard displayed on the display terminal 14a, such as the text. The methodology advances to block 130 and the user 14 may, for a fee, order a copy of the reference standard from the web site 40. The methodology advances to bubble 135 and ends.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A method of providing a reference standard on a web site on a computer network, said method comprising the steps of:
providing a web site on the computer network, wherein the web site includes a reference standard database;
identifying if a user can access the reference standard database on the web site;
selecting a search criteria for a reference standard by the user if the user can access the reference standard database;
searching the reference standard database for the reference standard using the search criteria; and
providing the user the reference standard identified by the search of the reference standard database.

2. The method as set forth in claim 1 including the step of subscribing to the reference standard service provided by the web site by the user.

3. A method as set forth in claim 1 including the step of acquiring and maintaining a database of reference standards by the web site.

4. A method as set forth in claim 1 including the step of providing the user with predetermined search options for searching the reference standard database on a web page on the web site.

5. A method as set forth in claim 1 including the step of providing the user with a selected reference standard for a fee.

6. A method as set forth in claim 1 wherein the computer network is the Internet.

7. A method as set forth in claim 1 wherein the web site is an E-commerce web site providing a reference standard service.

8. A method of providing a reference standard within a web site on an internet, said method comprising the steps of:
providing an E-commerce web site in communication with the Internet;
acquiring and maintaining a reference standard database of reference standards on a computer database by the web site;
identifying if a user visiting the web site can access the reference standard database on the web site;
selecting a search criteria for a reference standard by the user if the user can access the reference standard database;
searching the reference standard database for the reference standard using the search criteria; and
providing the user the reference standard identified by the search of the reference standard database.

9. A method as set forth in claim 8 including the step of subscribing to the reference standard service provided by the web site.

10. A method as set forth in claim 8 including the step of providing the user with a web page on the web site having predetermined search options for searching the reference standard database.

11. A method as set forth in claim 8 including the step of providing the user with a selected reference standard for a fee.

12. A method of providing a reference standard subscription service on a web site on an internet, said method comprising the steps of:
providing an E-commerce web site in communication with the Internet;
acquiring and maintaining a reference standard database of reference standards on a computer database by the web site;
subscribing to receive the reference standard service provided by the web site by a user;
identifying if the user visiting the web site has permission to access the reference standard database on the web site;
selecting a search criteria for a reference standard by the user if the user has permission to access the reference standard database;
searching the reference standard database for the reference standard using the search criteria; and
providing the user the reference standard identified by the search of the reference standard database for a fee.

13. A method as set forth in claim 12 including the step of providing the user with a web page on the web site having predetermined search options for searching the reference standard database.
